(19) United States
(12) Patent Application Publication
(10) Pub. No.: US 2022/0060821 A1
(43) Pub. Date: Feb. 24, 2022

(54) METHOD AND APPARATUS FOR OPTIMIZING DIFFERENTIAL MICROPHONE ARRAY BEAMFORMING

(71) Applicant: GoPro, Inc., San Mateo, CA (US)

(72) Inventors: Timothy Dick, San Francisco, CA (US); Erich Tisch, San Francisco, CA (US); Mark Hardin, Guerneville, CA (US)

(21) Appl. No.: 16/999,626

(22) Filed: Aug. 21, 2020

(51) Int. Cl. H04R 3/00; H04S 7/00

(52) U.S. Cl. CPC H04R 3/005; H04R 2203/12; H04S 7/307

(57) ABSTRACT

An electronic device may use differential microphone arrays for beamforming. The electronic device may include a first microphone for obtaining a first microphone signal and a second microphone for obtaining a second microphone signal. The electronic device may include a processor to process the microphone signals to obtain frequency bins. The processor may apply delay coefficients to the frequency bins of the microphone signals to obtain a delayed signal. The delay coefficients may be based on a phase difference between the microphone signals. The phase difference may be a function of frequency. The processor may be configured to combine the delayed signal with the first microphone signal or the second microphone signal to obtain a beamformed signal. The electronic device may include a memory to store the beamformed signal.

### TECHNICAL FIELD

This disclosure relates to differential microphone array beamforming.

### BACKGROUND

First order differential microphone arrays (DMA)s have been used in electronic devices to create stereo audio, for example by using two microphones in a line with a known spacing between them. Problems arise when the mechanical design of the electronic device or positioning of the microphones causes a deviation of the audio quality from an acoustically ideal design. Accordingly, a method and apparatus are needed to compensate for the degradation in beamforming performance of a DMA caused by the mechanical design of the electronic device.

### SUMMARY

Disclosed herein are implementations of differential microphone array (DMA) beamforming methods and devices. In an aspect, an image capture device may include a first microphone, a second microphone, a processor, and a memory. The first microphone may be configured to obtain a first microphone signal. The second microphone may be configured to obtain a second microphone signal. The processor may be configured to perform a transformation. The transformation may be performed on the first microphone signal, the second microphone signal, or both. The processor may perform the transformation to obtain frequency bins. The processor may be configured to apply respective delay coefficients to the frequency bins of the first microphone signal, the second microphone signal, or both. The respective delay coefficients may be applied to obtain a delayed signal. The respective delay coefficients may be based on a phase difference between the first microphone signal and the second microphone signal. The phase difference may be a function of frequency. The processor may be configured to combine the delayed signal. The delayed signal may be combined with the first microphone signal or the second microphone signal. The first microphone signal, the second microphone signal, or both may be delayed signals. The signals may be combined to obtain a beamformed signal. The memory may be configured to store the beamformed signal.

In an aspect, a DMA beamforming method may include obtaining respective microphone signals from two or more microphones. The DMA beamforming method may include performing a transformation. The transformation may be performed on the respective microphone signals to obtain frequency bins. The DMA beamforming method may include performing beamforming on the respective microphone signals. The beamforming may be based on an effective distance between the two or more microphones. The beamforming may be performed to obtain beamformed signals. The DMA beamforming method may include performing an inverse transformation. The inverse transformation may be performed on one or more beamformed signals to obtain time domain beamformed signals. The DMA beamforming method may include applying gains to the time domain beamformed signals. The DMA beamforming method may include encoding the time domain beamformed signals to obtain an encoded stream. The DMA beamforming method may include storing the encoded stream.

In an aspect, a DMA beamforming method may include obtaining a first microphone signal from a first microphone. The DMA beamforming method may include obtaining a second microphone signal from a second microphone. The DMA beamforming method may include performing a transformation on the first microphone signal, the second microphone signal, or both to obtain frequency bins. The DMA beamforming method may include applying a respective delay coefficient to each of the frequency bins of the first microphone signal, the second microphone signal, or both microphone signals. The respective delay coefficients may be applied to obtain a delayed signal. The respective delay coefficients may be based on an effective distance between the first microphone and the second microphone. The DMA beamforming method may include combining the delayed signal and the first microphone signal or the second microphone signal to obtain a beamformed signal. The DMA beamforming method may include storing the beamformed signal.

In one or more aspects, the respective delay coefficients may be variable for each respective frequency bin. In one or more aspects, a location of the first microphone relative to a location of the second microphone may be such that an effective distance between the first microphone and the second microphone deviates from a true distance between the first microphone and the second microphone. In one or more aspects, an average bin width of the frequency bins may be configured to match a fast Fourier transform (FFT) length. In one or more aspects, the FFT length may be 256. In one or more aspects, the average bin width may be approximately 93.75 Hz. In one or more aspects, the beamformed signal may produce a cardioid polar response, a hypercardioid polar response, or a supercardioid polar response. In one or more aspects, the effective distance may be based on a phase difference between the respective microphone signals.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-B are isometric views of an example of an image capture device.

FIGS. 2A-B are isometric views of another example of an image capture device.

FIG. 2C is a top view of the image capture device of FIGS. 2A-B.

FIG. 2D is a partial cross-sectional view of the image capture device of FIG. 2C.

FIG. 3 is a block diagram of electronic components of an image capture device.

FIG. 4 is a block diagram of an image capture device microphone configuration for differential microphone array beamforming.

FIG. 5A is a graph showing an example of a near-ideal phase response of a DMA.

FIG. 5B is a graph showing an example of a non-ideal phase response of a DMA.

FIG. 6 is a flow diagram of an example of a method for performing differential microphone array beamforming.

FIG. 7 is a flow diagram of another example of a method for performing differential microphone array beamforming.

FIG. 8A is a graph showing an example of polar responses where the effective distance of the microphones is properly calculated.

FIG. 8B is a graph showing an example of polar responses where the calculated effective distance of the microphones is too short.

FIG. 8C is a graph showing an example of polar responses where the calculated effective distance of the microphones is too long.

FIG. 9A shows graphs of example polar responses for a device configuration where a fixed delay is applied to the microphone signals.

FIG. 9B shows graphs of example polar responses for a device configuration where a bin-wise delay is applied to the microphone signals.

### DETAILED DESCRIPTION

Differential microphone array (DMA) beamforming may be achieved when the geometry and physical spacing between at least two microphones is known. Subtracting the outputs of closely spaced omnidirectional microphones may produce the differential of the acoustic pressure field. Building a delay into at least one microphone path before subtraction may create different beam patterns such as a cardioid, hypercardioid, or supercardioid.

In an ideal case, the measured time delay between the microphones are the same as the theoretical time delay based on the distance between the microphones. This is not always true when the mechanical design of an electronic device is considered. When the measured time delay deviates from the theoretical time delay, beamforming performance degrades. The mechanical design of the electronic device may have varying effects on different frequency bands. For example, some frequency bands may be more sensitive to the design of the electronic device than other frequency bands.

The process to compensate for this degradation may include measuring the phase difference between the microphones as a function of frequency to characterize the delay acoustically. Each microphone signal includes a number of frequency bands. Each frequency band may be divided into a number of frequency bins. Using the phase difference data, the coefficients applied in a beamforming algorithm may be optimized on a frequency bin-wise basis. The result may be seen as an improvement in the shape of the microphone system polar response.

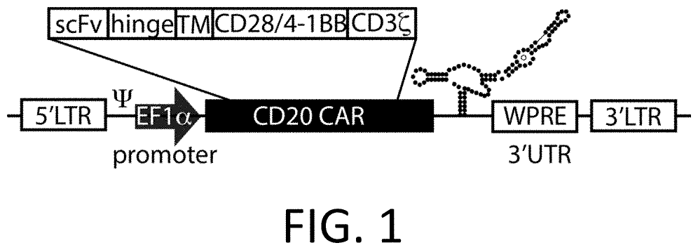

FIGS. 1A-B are isometric views of an example of an image capture device 100. The image capture device 100 may include a body 102, a lens 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor internal to the body 102. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (1/0) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a side surface. The image capture device 100 may include other microphones on other surfaces (not shown). The microphones 128, 130 may be configured to receive and record audio signals in conjunction with recording video or separate from recording of video. The microphones 128, 130 may be used to perform DMA beamforming in accordance with embodiments of this disclosure. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A front surface of the image capture device 100 may include a drainage channel 134. A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position as shown and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-B includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors, such as charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

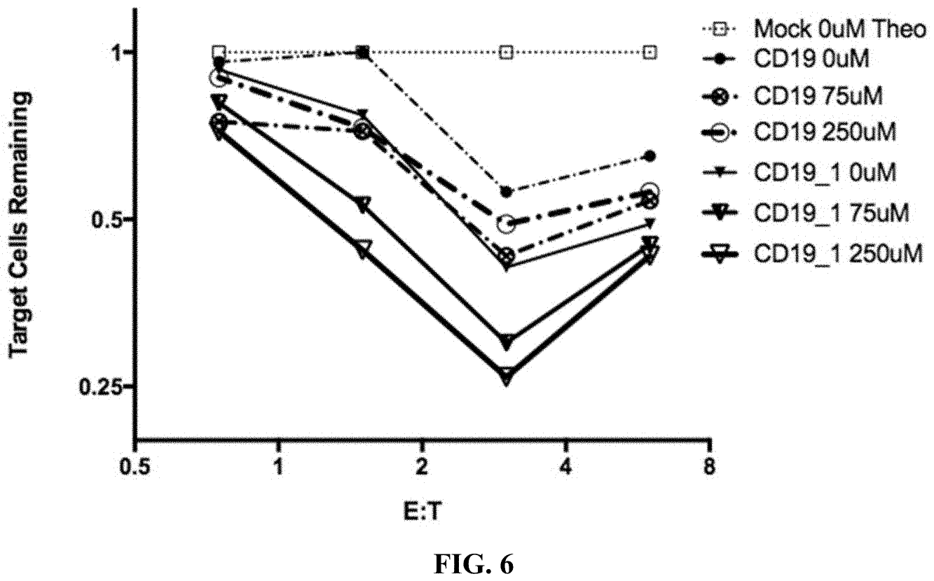

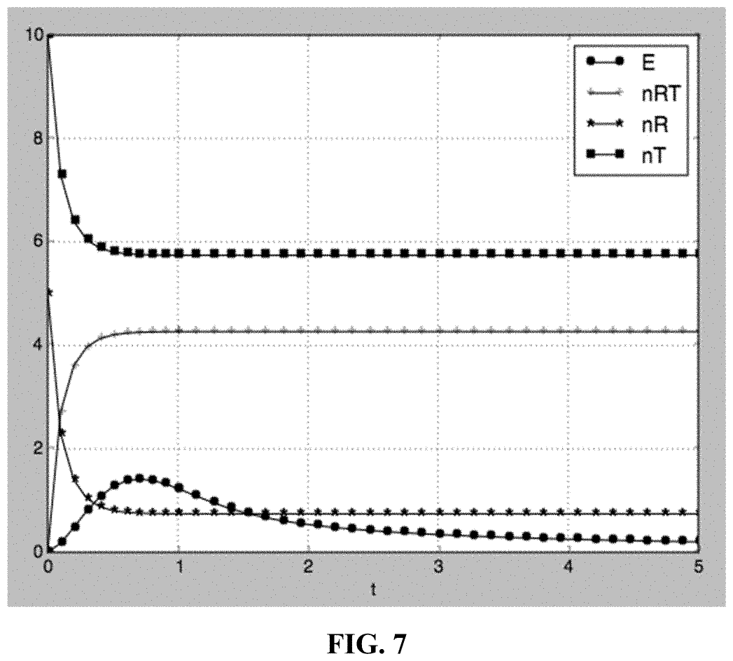

The image capture device 100 may be used to implement some or all of the techniques described in this disclosure, such as the method 600 described in FIG. 6, the method 700 described in FIG. 7, or both.

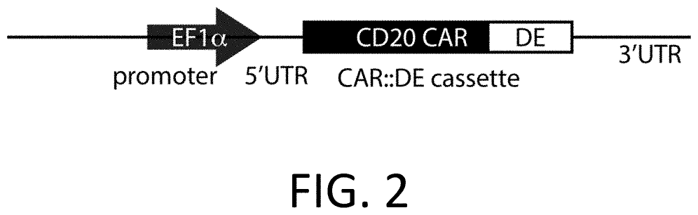

FIGS. 2A-B illustrate another example of an image capture device 200. The image capture device 200 includes a body 202 and two camera lenses 204 and 206 disposed on opposing surfaces of the body 202, for example, in a back-to-back configuration, Janus configuration, or offset Janus configuration. The body 202 of the image capture device 200 may be made of a rigid material such as plastic, aluminum, steel, or fiberglass.

The image capture device 200 includes various indicators on the front of the surface of the body 202 (such as LEDs, displays, and the like), various input mechanisms (such as buttons, switches, and touch-screen mechanisms), and electronics (e.g., imaging electronics, power electronics, etc.) internal to the body 202 that are configured to support image capture via the two camera lenses 204 and 206 and/or perform other imaging functions.

The image capture device 200 includes various indicators, for example, LEDs 208, 210 to indicate a status of the image capture device 100. The image capture device 200 may include a mode button 212 and a shutter button 214 configured to allow a user of the image capture device 200 to interact with the image capture device 200, to turn the image capture device 200 on, and to otherwise configure the operating mode of the image capture device 200. It should be appreciated, however, that, in alternate embodiments, the image capture device 200 may include additional buttons or inputs to support and/or control additional functionality.

The image capture device 200 may include an interconnect mechanism 216 for connecting the image capture device 200 to a handle grip or other securing device. In the example shown in FIGS. 2A and 2B, the interconnect mechanism 216 includes folding protrusions configured to move between a nested or collapsed position (not shown) and an extended or open position as shown that facilitates coupling of the protrusions to mating protrusions of other devices such as handle grips, mounts, clips, or like devices.

The image capture device 200 may include audio components 218, 220, 222 such as microphones configured to receive and record audio signals (e.g., voice or other audio commands) in conjunction with recording video. The audio component 218, 220, 222 can also be configured to play back audio signals or provide notifications or alerts, for example, using speakers. Placement of the audio components 218, 220, 222 may be on one or more of several surfaces of the image capture device 200. In the example of FIGS. 2A and 2B, the image capture device 200 includes three audio components 218, 220, 222, with the audio component 218 on a front surface, the audio component 220 on a side surface, and the audio component 222 on a back surface of the image capture device 200. Other numbers and configurations for the audio components are also possible. Two or more of the audio components 218, 220, 222 may be used to perform DMA beamforming in accordance with embodiments of this disclosure.

The image capture device 200 may include an interactive display 224 that allows for interaction with the image capture device 200 while simultaneously displaying information on a surface of the image capture device 200. The interactive display 224 may include an I/O interface, receive touch inputs, display image information during video capture, and/or provide status information to a user. The status information provided by the interactive display 224 may include battery power level, memory card capacity, time elapsed for a recorded video, etc.

The image capture device 200 may include a release mechanism 225 that receives a user input to in order to change a position of a door (not shown) of the image capture device 200. The release mechanism 225 may be used to open the door (not shown) in order to access a battery, a battery receptacle, an I/O interface, a memory card interface, etc. (not shown) that are similar to components described in respect to the image capture device 100 of FIGS. 1A and 1B.

In some embodiments, the image capture device 200 described herein includes features other than those described. For example, instead of the I/O interface and the interactive display 224, the image capture device 200 may include additional interfaces or different interface features. For example, the image capture device 200 may include additional buttons or different interface features, such as interchangeable lenses, cold shoes, and hot shoes that can add functional features to the image capture device 200.

FIG. 2C is a top view of the image capture device 200 of FIGS. 2A-B and FIG. 2D is a partial cross-sectional view of the image capture device 200 of FIG. 2C. The image capture device 200 is configured to capture spherical images, and accordingly, includes a first image capture device 226 and a second image capture device 228. The first image capture device 226 defines a first field-of-view 230 and includes the lens 204 that receives and directs light onto a first image sensor 232. Similarly, the second image capture device 228 defines a second field-of-view 234 and includes the lens 206 that receives and directs light onto a second image sensor 236. To facilitate the capture of spherical images, the image capture devices 226 and 228 (and related components) may be arranged in a back-to-back (Janus) configuration such that the lenses 204, 206 face in generally opposite directions.

The fields-of-view 230, 234 of the lenses 204, 206 are shown above and below boundaries 238, 240 indicated in dotted line. Behind the first lens 204, the first image sensor 232 may capture a first hyper-hemispherical image plane from light entering the first lens 204, and behind the second lens 206, the second image sensor 236 may capture a second hyper-hemispherical image plane from light entering the second lens 206.

One or more areas, such as blind spots 242, 244 may be outside of the fields-of-view 230, 234 of the lenses 204, 206 so as to define a “dead zone.” In the dead zone, light may be obscured from the lenses 204, 206 and the corresponding image sensors 232, 236, and content in the blind spots 242, 244 may be omitted from capture. In some implementations, the image capture devices 226, 228 may be configured to minimize the blind spots 242, 244.

The fields-of-view 230, 234 may overlap. Stitch points 246, 248 proximal to the image capture device 200, that is, locations at which the fields-of-view 230, 234 overlap, may be referred to herein as overlap points or stitch points. Content captured by the respective lenses 204, 206 that is distal to the stitch points 246, 248 may overlap.

Images contemporaneously captured by the respective image sensors 232, 236 may be combined to form a combined image. Generating a combined image may include correlating the overlapping regions captured by the respective image sensors 232, 236, aligning the captured fields-of-view 230, 234, and stitching the images together to form a cohesive combined image.

A slight change in the alignment, such as position and/or tilt, of the lenses 204, 206, the image sensors 232, 236, or both, may change the relative positions of their respective fields-of-view 230, 234 and the locations of the stitch points 246, 248. A change in alignment may affect the size of the blind spots 242, 244, which may include changing the size of the blind spots 242, 244 unequally.

Incomplete or inaccurate information indicating the alignment of the image capture devices 226, 228, such as the locations of the stitch points 246, 248, may decrease the accuracy, efficiency, or both of generating a combined image. In some implementations, the image capture device 200 may maintain information indicating the location and orientation of the lenses 204, 206 and the image sensors 232, 236 such that the fields-of-view 230, 234, the stitch points 246, 248, or both may be accurately determined; the maintained information may improve the accuracy, efficiency, or both of generating a combined image.

The lenses 204, 206 may be laterally offset from each other, may be off-center from a central axis of the image capture device 200, or may be laterally offset and off-center from the central axis. As compared to image capture devices with back-to-back lenses, such as lenses aligned along the same axis, image capture devices including laterally offset lenses may include substantially reduced thickness relative to the lengths of the lens barrels securing the lenses. For example, the overall thickness of the image capture device 200 may be close to the length of a single lens barrel as opposed to twice the length of a single lens barrel as in a back-to-back lens configuration. Reducing the lateral distance between the lenses 204, 206 may improve the overlap in the fields-of-view 230, 234. In another embodiment (not shown), the lenses 204, 206 may be aligned along a common imaging axis.

Images or frames captured by the image capture devices 226, 228 may be combined, merged, or stitched together to produce a combined image, such as a spherical or panoramic image, which may be an equirectangular planar image. In some implementations, generating a combined image may include use of techniques including noise reduction, tone mapping, white balancing, or other image correction. In some implementations, pixels along the stitch boundary may be matched accurately to minimize boundary discontinuities.

The image capture device 200 may be used to implement some or all of the techniques described in this disclosure, such as the method 600 described in FIG. 6, the method 700 described in FIG. 7, or both.

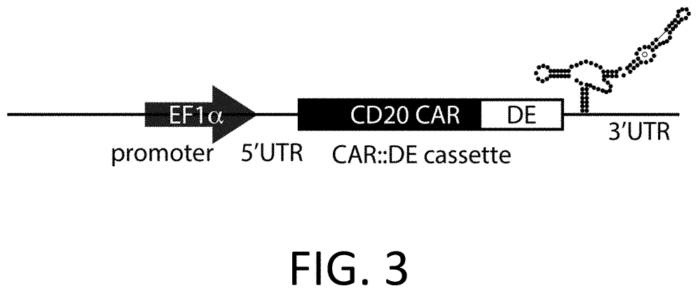

FIG. 3 is a block diagram of electronic components in an image capture device 300. The image capture device 300 may be a single-lens image capture device, a multi-lens image capture device, or variations thereof, including an image capture device with multiple capabilities such as use of interchangeable integrated sensor lens assemblies. The description of the image capture device 300 is also applicable to the image capture devices 100, 200 of FIGS. 1A-B and 2A-D.

The image capture device 300 includes a body 302 which includes electronic components such as capture components 310, a processing apparatus 320, data interface components 330, movement sensors 340, power components 350, and/or user interface components 360.

The capture components 310 include one or more image sensors 312 for capturing images and one or more microphones 314 for capturing audio.

The image sensor(s) 312 is configured to detect light of a certain spectrum (e.g., the visible spectrum or the infrared spectrum) and convey information constituting an image as electrical signals (e.g., analog or digital signals). The image sensor(s) 312 detects light incident through a lens coupled or connected to the body 302. The image sensor(s) 312 may be any suitable type of image sensor, such as a charge-coupled device (CCD) sensor, active pixel sensor (APS), complementary metal-oxide-semiconductor (CMOS) sensor, N-type metal-oxide-semiconductor (NMOS) sensor, and/or any other image sensor or combination of image sensors. Image signals from the image sensor(s) 312 may be passed to other electronic components of the image capture device 300 via a bus 380, such as to the processing apparatus 320. In some implementations, the image sensor(s) 312 includes a digital-to-analog converter. A multi-lens variation of the image capture device 300 can include multiple image sensors 312.

The microphone(s) 314 is configured to detect sound, which may be recorded in conjunction with capturing images to form a video. The microphone(s) 314 may also detect sound in order to receive audible commands to control the image capture device 300.

The processing apparatus 320 may be configured to perform image signal processing (e.g., filtering, tone mapping, stitching, and/or encoding) to generate output images based on image data from the image sensor(s) 312. The processing apparatus 320 may include one or more processors having single or multiple processing cores. In some implementations, the processing apparatus 320 may include an application specific integrated circuit (ASIC). For example, the processing apparatus 320 may include a custom image signal processor. The processing apparatus 320 may exchange data (e.g., image data) with other components of the image capture device 300, such as the image sensor(s) 312, via the bus 380. The processing apparatus 320 may be configured to perform DMA beamforming in accordance with embodiments of this disclosure.

The processing apparatus 320 may include memory, such as a random-access memory (RAM) device, flash memory, or another suitable type of storage device, such as a non-transitory computer-readable memory. The memory of the processing apparatus 320 may include executable instructions and data that can be accessed by one or more processors of the processing apparatus 320. For example, the processing apparatus 320 may include one or more dynamic random-access memory (DRAM) modules, such as double data rate synchronous dynamic random-access memory (DDR SDRAM). In some implementations, the processing apparatus 320 may include a digital signal processor (DSP). More than one processing apparatus may also be present or associated with the image capture device 300.

The data interface components 330 enable communication between the image capture device 300 and other electronic devices, such as a remote control, a smartphone, a tablet computer, a laptop computer, a desktop computer, or a storage device. For example, the data interface components 330 may be used to receive commands to operate the image capture device 300, transfer image data to other electronic devices, and/or transfer other signals or information to and from the image capture device 300. The data interface components 330 may be configured for wired and/or wireless communication. For example, the data interface components 330 may include an I/O interface 332 that provides wired communication for the image capture device, which may be a USB interface (e.g., USB type-C), a high-definition multimedia interface (HDMI), or a FireWire interface. The data interface components 330 may include a wireless data interface 334 that provides wireless communication for the image capture device 300, such as a Bluetooth interface, a ZigBee interface, and/or a Wi-Fi interface. The data interface components 330 may include a storage interface 336, such as a memory card slot configured to receive and operatively couple to a storage device (e.g., a memory card) for data transfer with the image capture device 300 (e.g., for storing captured images and/or recorded audio and video).

The movement sensors 340 may detect the position and movement of the image capture device 300. The movement sensors 340 may include a position sensor 342, an accelerometer 344, or a gyroscope 346. The position sensor 342, such as a global positioning system (GPS) sensor, is used to determine a position of the image capture device 300. The accelerometer 344, such as a three-axis accelerometer, measures linear motion (e.g., linear acceleration) of the image capture device 300. The gyroscope 346, such as a three-axis gyroscope, measures rotational motion (e.g., rate of rotation) of the image capture device 300. Other types of movement sensors 340 may also be present or associated with the image capture device 300.

The power components 350 may receive, store, and/or provide power for operating the image capture device 300. The power components 350 may include a battery interface 352 and a battery 354. The battery interface 352 operatively couples to the battery 354, for example, with conductive contacts to transfer power from the battery 354 to the other electronic components of the image capture device 300. The power components 350 may also include an external interface 356, and the power components 350 may, via the external interface 356, receive power from an external source, such as a wall plug or external battery, for operating the image capture device 300 and/or charging the battery 354 of the image capture device 300. In some implementations, the external interface 356 may be the I/O interface 332. In such an implementation, the I/O interface 332 may enable the power components 350 to receive power from an external source over a wired data interface component (e.g., a USB type-C cable).

The user interface components 360 may allow the user to interact with the image capture device 300, for example, providing outputs to the user and receiving inputs from the user. The user interface components 360 may include visual output components 362 to visually communicate information and/or present captured images to the user. The visual output components 362 may include one or more lights 364 and/or more displays 366. The display(s) 366 may be configured as a touch screen that receives inputs from the user. The user interface components 360 may also include one or more speakers 368. The speaker(s) 368 can function as an audio output component that audibly communicates information and/or presents recorded audio to the user. The user interface components 360 may also include one or more physical input interfaces 370 that are physically manipulated by the user to provide input to the image capture device 300. The physical input interfaces 370 may, for example, be configured as buttons, toggles, or switches. The user interface components 360 may also be considered to include the microphone(s) 314, as indicated in dotted line, and the microphone(s) 314 may function to receive audio inputs from the user, such as voice commands.

The image capture device 300 may be used to implement some or all of the techniques described in this disclosure, such as the method 600 described in FIG. 6, the method 700 described in FIG. 7, or both.

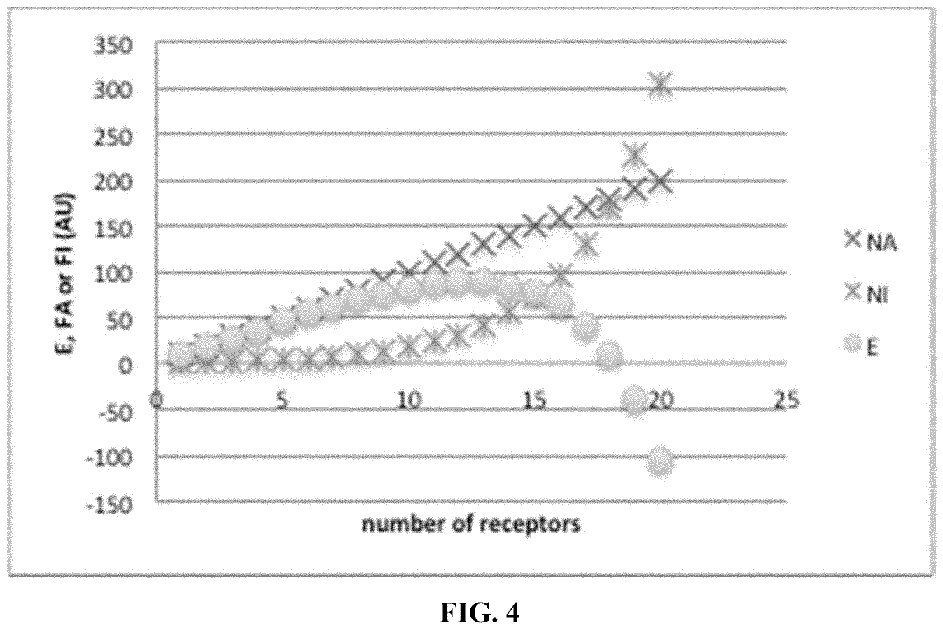

FIG. 4 is a block diagram of an example of an image capture device microphone configuration 400 for differential microphone array beamforming. As shown in FIG. 4, an image capture device 410 includes a lens 420, a microphone 430A, a microphone 430B, a microphone 440A, and a microphone 440B. One or more of the microphones 430A, 430B, 440A, 440B may be omnidirectional microphones. The microphones 430A and 430B may be configured to perform DMA beamforming in accordance with embodiments of this disclosure. In this example, the microphones 430A and 430B may perform DMA beamforming to produce a stereo beam pattern. As shown in FIG. 4, the microphone 430A may be configured to produce a cardioid beam pattern that represents a left acoustic lobe 450A of the stereo beam pattern and the microphone 430B may be configured to produce a cardioid beam pattern that represents a right acoustic lobe 450B of the stereo beam pattern. The left acoustic lobe 450A of the stereo beam pattern includes a null area 455A where the delayed and subtracted signal from the microphone 430B is canceled out. Similarly, the right acoustic lobe 450B of the stereo beam pattern includes a null area 455B where the delayed and subtracted signal from the microphone 430A is canceled out.

The microphones 440A and 440B may be configured to perform DMA beamforming in accordance with embodiments of this disclosure. In this example, the microphones 440A and 440B may perform DMA beamforming to produce a beam pattern. As shown in FIG. 4, the microphone 440A may be configured to produce a cardioid beam pattern that represents a forward acoustic lobe 460A of the beam pattern and the microphone 440B may be configured to produce a cardioid beam pattern that represents a reverse acoustic lobe 460B of the beam pattern. The forward acoustic lobe 460A may include sound waves captured from the front of the image capture device 410 and the reverse acoustic lobe 460B may include sound waves captured from behind the image capture device 400. The forward acoustic lobe 460A of the beam pattern includes a null area 465A where the delayed and subtracted signal from the microphone 440B is canceled out. Similarly, the reverse acoustic lobe 460B of the beam pattern includes a null area 465B where the delayed and subtracted signal from the microphone 440A is canceled out. Although the beamforming microphones 440A, 440B in the example shown in FIG. 4 are shown in pairs, it is understood that any number of microphones may be used.

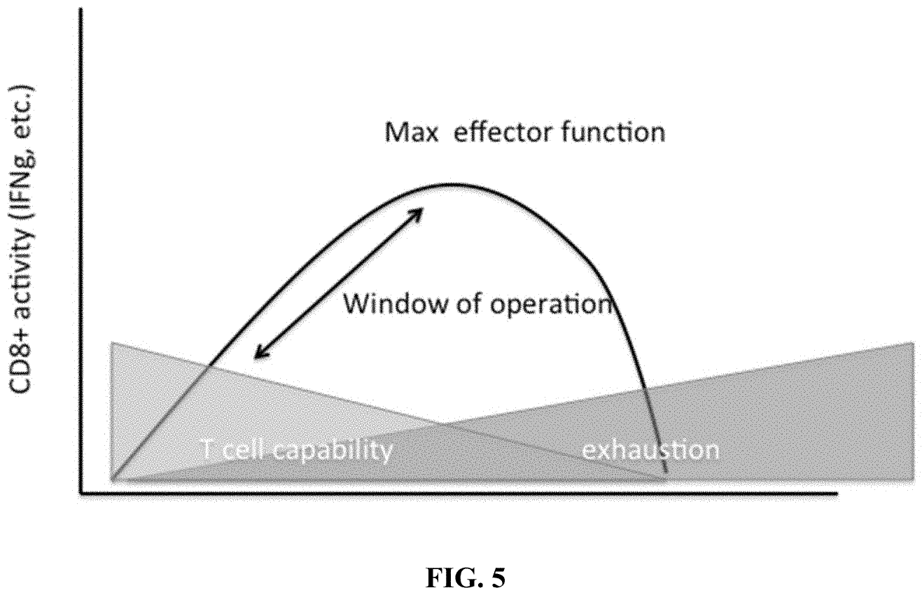

FIG. 5A is a graph 500 showing an example of a near-ideal phase response 510 of a DMA. In this example, the near-ideal phase response 510 may be obtained using two or more microphones positioned approximately 14 mm apart on a flat surface. The two or more microphones in this example may be positioned facing the same direction. The graph 500 shows a phase difference between the near-ideal phase response 510 and a theoretical ideal phase response 520. The phase difference between the near-ideal phase response 510 and the theoretical ideal phase response 520 may be used to calculate the effective distance between the two or more microphones.

In this example, the effective distance appears approximately the same across the frequency range. The closer the near-ideal phase response 510 fits to the theoretical ideal audio response 520, the better the fit, the closer the polar response will be to a perfect cardioid pattern. In this example, the microphone configuration produces a greater deviation of the phase difference in the frequency ranges from approximately 4000 to 8000 Hz.

FIG. 5B is a graph 550 showing an example of a non-ideal phase response 560 of a DMA. In this example, the non-ideal phase response 560 may be obtained using two or more microphones. The two or more microphones may be positioned such that imperfections in the mechanical design of the electronic device result in a deviation between the effective distance between the microphones from the true distance between the microphones. For example, the geometry of the electronic device may cause the deviation. In another example, the microphones may be positioned in an encasement, and the geometry of the encasement may cause the deviation. The graph 550 shows a phase difference between the non-ideal phase response 560 and a theoretical ideal phase response 570. Since the phase difference and the effective distance are directly correlated, the phase difference between the non-ideal phase response 560 and the theoretical ideal phase response 570 may be used to calculate the effective distance between the two or more microphones.

In this example, the effective distance appears to deviate from the theoretical ideal phase response 570 across most of the frequency range. The closer the non-ideal phase response 560 fits to theoretical ideal phase response 570, the better the fit, the closer the polar response will be to a perfect cardioid pattern. In this example, the microphone configuration produces a greater deviation of the phase difference in the frequency ranges from approximately 4000 to 8000 Hz and above approximately 8500 Hz. As shown in FIG. 5B, the deviation of the non-ideal phase response 560 is greater than the deviation of the ideal phase response 510 shown in FIG. 5A. Accordingly, the positioning of the microphones has a significant effect on the microphone performance and polar response. The embodiments disclosed herein compensate for the negative acoustic effects of microphone positioning and electronic device geometry.

FIG. 6 is a flow diagram of an example of a method 600 for performing differential microphone array beamforming. The method 600 includes obtaining 610 microphone signals. The microphone signals may be obtained from two or more microphones. At least one of the two or more microphones may be an omnidirectional microphone. The microphone signals may be obtained in a time domain. The two or more microphones may be located on an electronic device such that an effective distance between the microphones is different than a true distance between the microphones. For example, the geometry of the electronic device may cause the deviation. In another example, the microphones may be positioned in an encasement, and the geometry of the encasement may cause the deviation.

The method 600 includes performing 620 a transformation. Performing 620 the transformation may include converting the microphone signals obtained in the time domain to a frequency domain. In an example, the transformation may be performed using a fast Fourier transform (FFT) or any other suitable algorithm. Performing 620 the transformation may include dividing each microphone signal into frequency bins. Dividing each microphone signal may include partitioning or sampling.

The method 600 includes performing 630 beamforming. The beamforming may be performed to obtain a beamformed signal that produces a cardioid polar response, a hypercardioid polar response, or a supercardioid polar response. The beamforming may be performed on any combination of the two or more microphone signals to obtain a respective beamformed signal. The beamforming may be performed on the respective microphone signals based on an effective distance between the two or more microphones. The effective distance between the two or more microphones may be calculated based on a phase difference between the two or more microphones.

The phase difference may be expressed as a function of frequency. A respective time delay may be determined using the phase difference for each frequency bin. Accordingly, a beamforming algorithm may include delay coefficients based on the effective distance that may be applied to each microphone signal on a frequency bin-wise basis. The delay coefficients for each respective frequency bin may be variable. In an example, an average bin width of the frequency bins may be configured to match an FFT length. The FFT length may be determined based on the desired resolution. For example, the FFT length may be set to 256 to achieve an average bin width of approximately 93.75 Hz.

The method 600 includes performing 640 an inverse transformation on the beamformed signals. The inverse transformation may be used to convert the beamformed signals into the time domain. In an example, the transformation may be performed using an inverse FFT or any other suitable algorithm. In some examples, the method 600 includes applying 650 gains to the time domain beamformed signals. Applying 650 the gains may amplify the microphone signals to an audible level.

The method 600 includes encoding 660 a stream. Encoding 660 the stream may include encoding the time domain beamformed signals to obtain the encoded stream. The stream may be encoded in any suitable digital multimedia format that used to store video data, audio data, image data and the like, for example a Moving Picture Experts Group 4 (MPEG-4) format. In some examples, the amplified time domain beamformed signals may be encoded. The method 600 may include storing 670 the encoded stream.

FIG. 7 is a flow diagram of another example of a method for performing differential microphone array beamforming. The method 700 includes obtaining 710 a first microphone signal. The first microphone signal may be obtained from an omnidirectional microphone. The first microphone signal may be obtained in a time domain.

The method 700 includes obtaining 720 a second microphone signal. The second microphone signal may be obtained from an omnidirectional microphone. The second microphone signal may be obtained in a time domain.

The first microphone signal and the second microphone signal may be obtained from microphones that are located on an electronic device such that an effective distance between the microphones is different than a true distance between the microphones. For example, the geometry of the electronic device may cause the deviation. In another example, the microphones may be positioned in an encasement, and the geometry of the encasement may cause the deviation.

The method 700 includes performing 730 a transformation. Performing 730 the transformation may include converting the microphone signals obtained in the time domain to a frequency domain. In an example, the transformation may be performed using an FFT or any other suitable algorithm. Performing 730 the transformation may include dividing each microphone signal into frequency bins. Dividing each microphone signal may include partitioning or sampling.

The method 700 includes applying 740 delay coefficients to obtain a delayed signal. The delay coefficients may be applied on the first microphone signal, the second microphone signal, or both to obtain one or more delayed signals. In this example, the delay coefficients may be applied to the second microphone signal. The delay coefficients may be determined based on an effective distance between the first microphone and the second microphone. The effective distance between the first microphone and the second microphone may be calculated based on a phase difference between the first microphone and the second microphone.

The phase difference may be expressed as a function of frequency. A respective time delay may be determined using the phase difference for each frequency bin. Accordingly, a beamforming algorithm may include delay coefficients based on the effective distance that may be applied to each microphone signal on a frequency bin-wise basis. The delay coefficients for each respective frequency bin may be variable. In an example, an average bin width of the frequency bins may be configured to match an FFT length. The FFT length may be determined based on the desired resolution. For example, the FFT length may be set to 256 to achieve an average bin width of approximately 93.75 Hz.

The method 700 includes combining 750 the delayed signal first microphone signal to obtain a beamformed signal. In some examples, the first microphone signal may also be a delayed signal. The beamformed signal may produce a cardioid polar response, a hypercardioid polar response, or a supercardioid polar response.

The method 700 includes storing 760 the beamformed signal. The beamformed signal may be stored in any suitable digital multimedia format that used to store video data, audio data, image data and the like, for example an MPEG-4 format. The beamformed signal may be stored in a memory, such as processing apparatus 320 shown in FIG. 3.

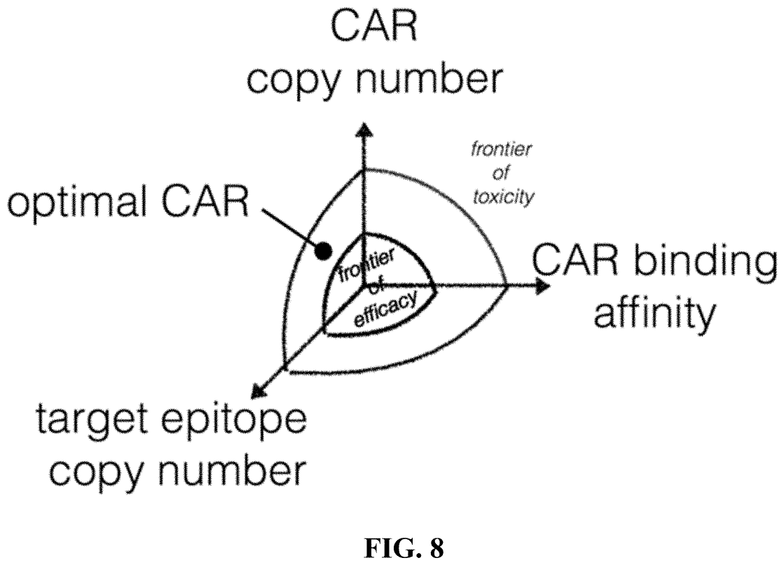

FIG. 8A is a graph showing an example of polar responses 800A where the effective distance of the microphones is properly calculated. In this example, two microphones separated by a distance of approximately 8.0 mm are used to obtain the polar responses 800A. The polar responses for different frequencies are shown to illustrate differences in polar responses between frequency ranges.

Referring to FIG. 8A, a 0.5 kHz polar response 810A, a 1.0 kHz polar response 820A, a 3.0 kHz polar response 830A, a 5.0 kHz polar response 840A, a 10.0 kHz polar response 850A, and a 20.0 kHz polar response 860A are shown. In this example, each of the 0.5 kHz polar response 810A, 1.0 kHz polar response 820A, 3.0 kHz polar response 830A, 5.0 kHz polar response 840A, 10.0 kHz polar response 850A, and 20.0 kHz polar response 860A exhibit a null area 870A where the delayed and subtracted signal from the second microphone is canceled out and a directional lobe 880A indicating a properly beamformed directional signal. The null area 870A and the directional lobe 880A in this example indicate that the effective distance of the microphones is properly calculated for all the frequencies shown.

FIG. 8B is a graph showing an example of polar responses 800B where the calculated effective distance of the microphones is too short. In this example, two microphones separated by a distance of approximately 8.0 mm are used to obtain the polar responses 800B. The polar responses for different frequencies are shown to illustrate differences in polar responses between frequency ranges.

Referring to FIG. 8B, a 0.5 kHz polar response 810B, a 1.0 kHz polar response 820B, a 3.0 kHz polar response 830B, a 5.0 kHz polar response 840B, a 10.0 kHz polar response 850B, and a 20.0 kHz polar response 860B are shown. In this example, each of the 0.5 kHz polar response 810B, 1.0 kHz polar response 820B, 3.0 kHz polar response 830B, 5.0 kHz polar response 840B, 10.0 kHz polar response 850B, and 20.0 kHz polar response 860B exhibit a polar pattern where a secondary lobe 870B is produced resulting from the signal from the second microphone not being sufficiently canceled out. The secondary lobe 870B in this example indicates that the calculated effective distance of the microphones is too short for all the frequencies shown. This may be exhibited as two nulls mirrored about 180 degrees instead of a single null at 180 degrees.

FIG. 8C is a graph showing an example of polar responses 800C where the calculated effective distance of the microphones is too long. In this example, two microphones separated by a distance of approximately 8.0 mm are used to obtain the polar responses 800C. The polar responses for different frequencies are shown to illustrate differences in polar responses between frequency ranges.

Referring to FIG. 8C, a 0.5 kHz polar response 810C, a 1.0 kHz polar response 820C, a 3.0 kHz polar response 830C, a 5.0 kHz polar response 840C, a 10.0 kHz polar response 850C, and a 20.0 kHz polar response 860C are shown. In this example, each of the 0.5 kHz polar response 810C, 1.0 kHz polar response 820C, 3.0 kHz polar response 830C, 5.0 kHz polar response 840C, and 10.0 kHz polar response 850C exhibit an omnidirectional pattern resulting from the signal from the second microphone not being sufficiently canceled out. The 20.0 kHz polar response 860C in this example exhibits a hypercardioid pattern, where some cancelation of the second microphone is achieved at this frequency, however this amount of cancelation is insufficient to produce a desired directional signal. The combination of omnidirectional and hypercardioid patterns indicate that the calculated effective distance of the microphones is too long for all the frequencies shown.

The directional polar responses shown in FIG. 8A indicates that a variable delay applied to the signal for each frequency bin produced an effective distance between the microphones that is substantially the same as the actual distance between the microphones in this device configuration. Accordingly, applying a variable delay to each of the frequency bins of the signal is sufficient for producing a suitable directional signal for this device configuration. By way of contrast, when the effective distance is not properly calculated, polar responses such as those shown in FIG. 8B and FIG. 8C may be observed.

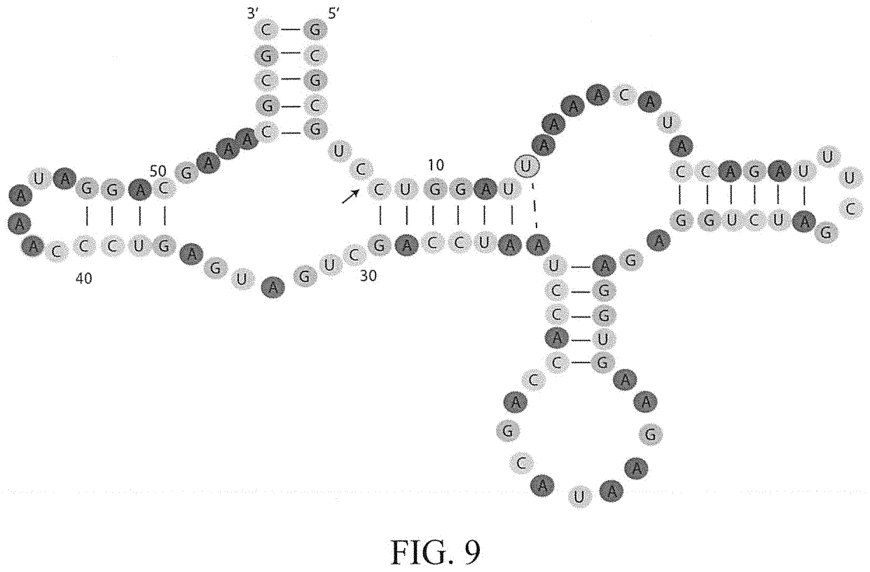

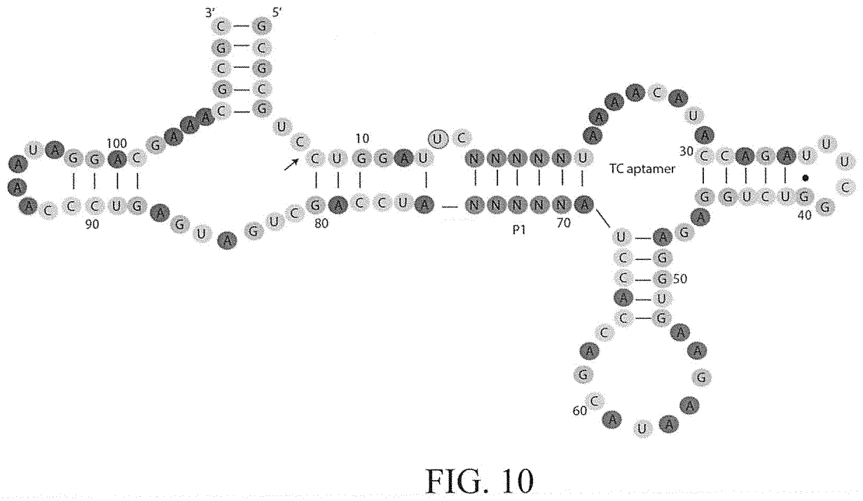

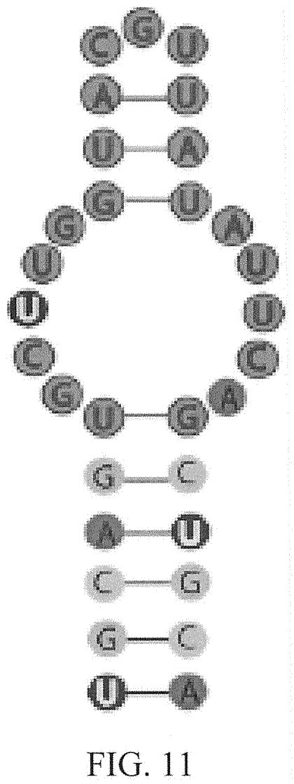

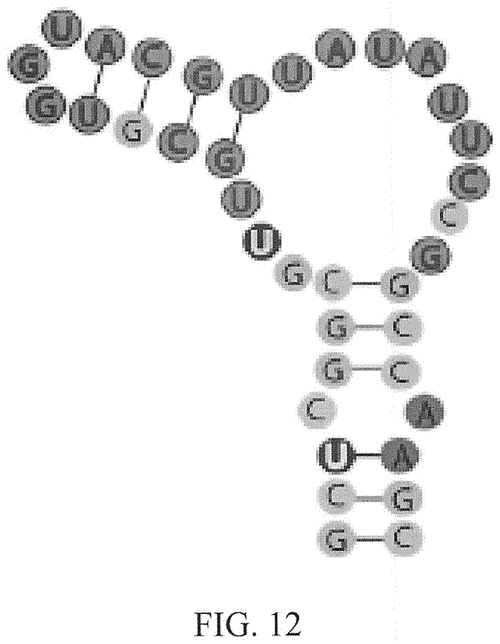

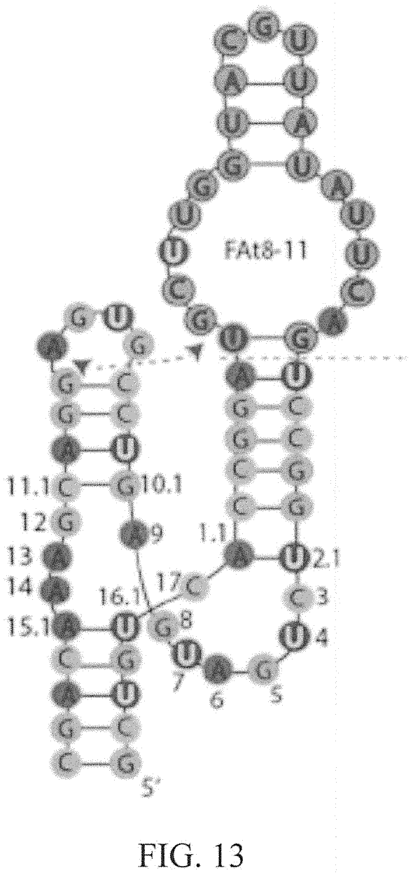

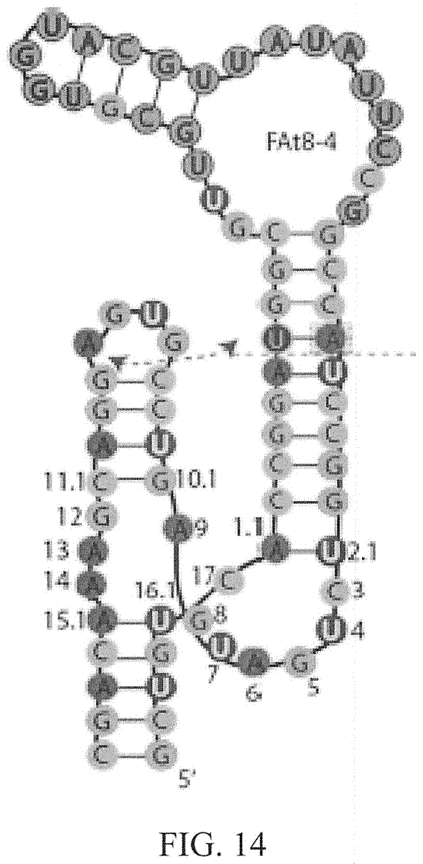

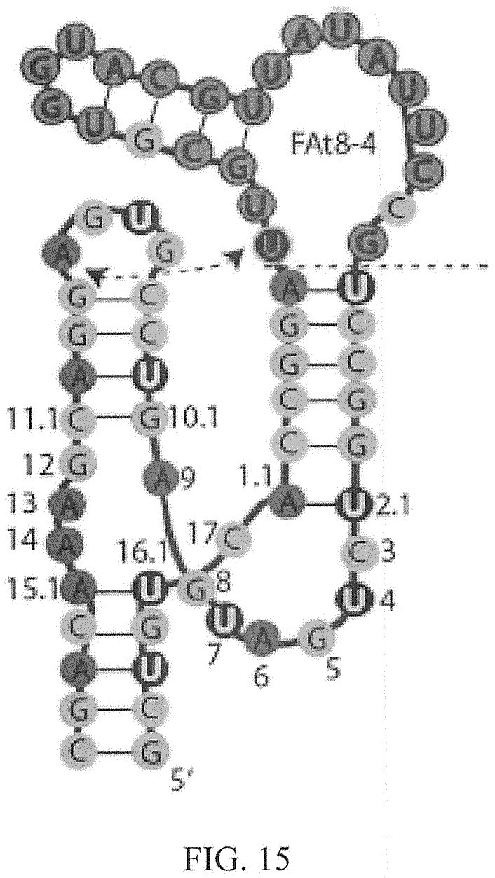

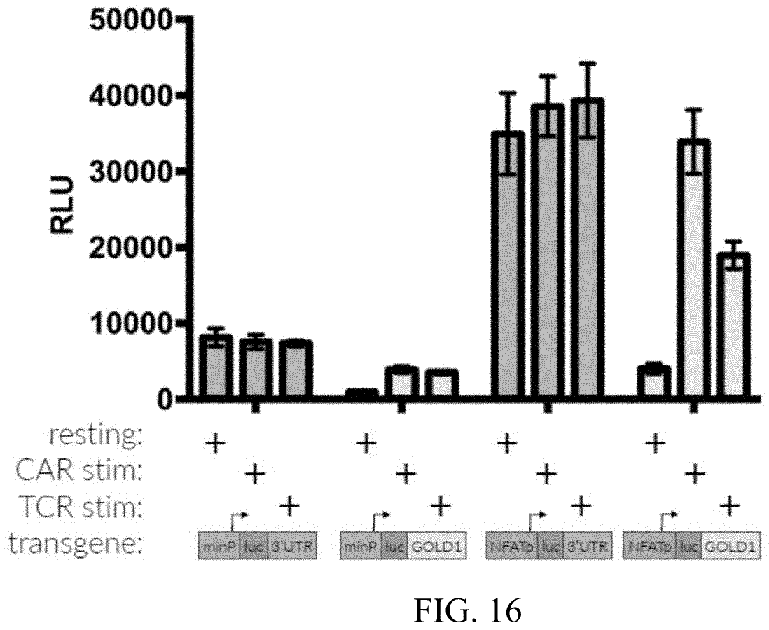

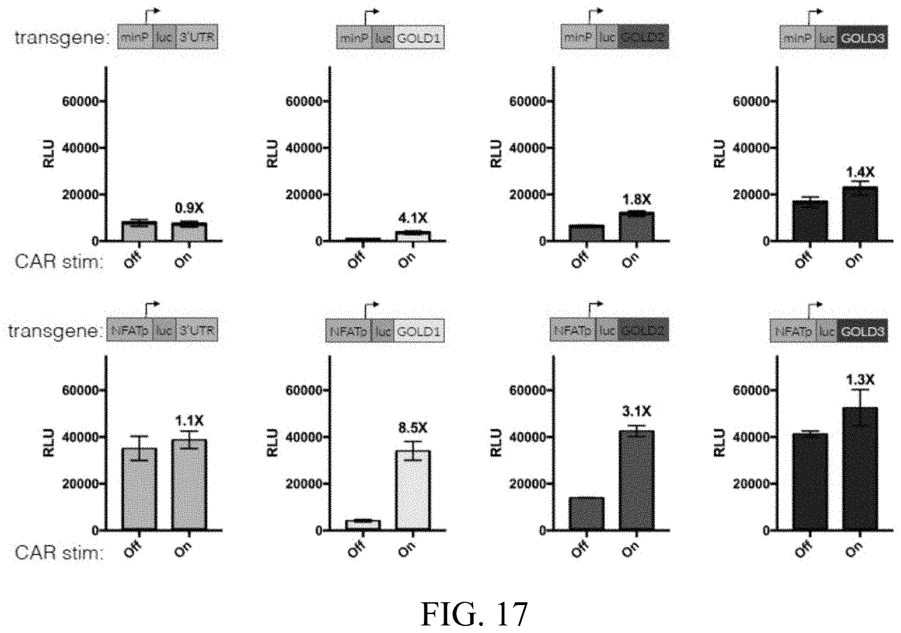

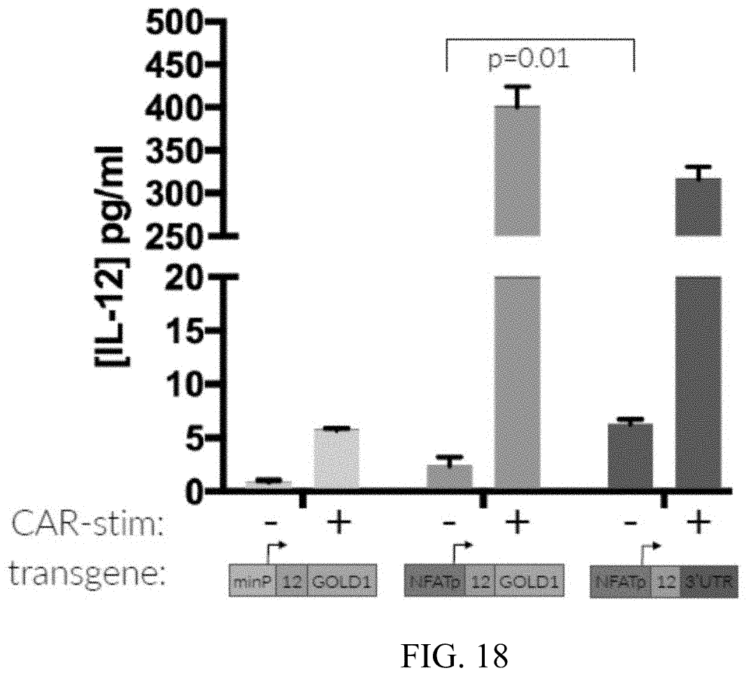

FIG. 9A shows graphs 900A of example polar responses for a device configuration where a fixed delay is applied to the microphone signals. FIG. 9A shows a polar response 910A for a signal at a frequency of 4000 Hz and a polar response 920A for the signal at a frequency of 6000 Hz. In this example, a fixed delay based on a theoretical phase response was applied to the signal. As shown in FIG. 9A, the fixed delay applied to the signal produces omnidirectional polar responses 910A, 920A at both frequencies. The omnidirectional polar responses 910A, 920A indicate that the effective distance between the microphones is different than the actual distance between the microphones in this device configuration. Accordingly, applying a fixed delay to the signal across all frequencies is insufficient for producing a suitable directional signal for this device configuration.

FIG. 9B shows graphs 900B of example polar responses for a device configuration where a bin-wise delay is applied to the microphone signals. The delay may include delay coefficients applied to a beamforming algorithm. The delay coefficients may be based on the effective distance that may be applied to each microphone signal on a frequency bin-wise basis based on a measured phase response. The delay coefficients for each respective frequency bin may be variable. In other words, the delay coefficients may be frequency dependent. In an example, an average bin width of the frequency bins may be configured to match an FFT length. The FFT length may be determined based on the desired resolution. For example, the FFT length may be set to 256 to achieve an average bin width of approximately 93.75 Hz.

FIG. 9B shows a polar response 910B for a signal at a frequency of 4000 Hz and a polar response 920B for the signal at a frequency of 6000 Hz. In this example, a variable delay was applied to each frequency bin of the signal. As shown in FIG. 9B, the variable delay applied to each frequency bin of the signal produces directional polar responses 910B, 920B at both frequencies. The directional polar responses 910B, 920B indicate that the variable delay applied to the signal for each frequency bin produced an effective distance between the microphones that is substantially the same as the actual distance between the microphones in this device configuration. Accordingly, applying a variable delay to each of the frequency bins of the signal is sufficient for producing a suitable directional signal for this device configuration.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. An image capture device comprising:
a first microphone disposed in an encasement, the first microphone configured to obtain a first microphone signal;
a second microphone disposed in the encasement, the second microphone configured to obtain a second microphone signal;
a processor configured to:
perform a transformation on the second microphone signal to obtain frequency bins;
apply respective delay coefficients to the frequency bins of the second microphone signal to obtain a delayed signal, wherein the respective delay coefficients are based on a measured phase difference between the first microphone signal and the second microphone signal as a function of frequency, wherein the measured phase difference is associated with a deviation caused by the encasement; and
combine the delayed signal and the first microphone signal to obtain a beamformed signal; and
a memory configured to store the beamformed signal.

2. The image capture device of claim 1, wherein the respective delay coefficients are variable for each respective frequency bin.

3. The image capture device of claim 1, wherein a location of the first microphone relative to a location of the second microphone is such that an effective distance between the first microphone and the second microphone deviates from a true distance between the first microphone and the second microphone.

4. The image capture device of claim 1, wherein an average bin width of the frequency bins is configured to match a Fast Fourier Transform (FFT) length.

5. The image capture device of claim 4, wherein the FFT length is 256.

6. The image capture device of claim 4, wherein the average bin width is approximately 93.75 Hz.

7. The image capture device of claim 1, wherein the beamformed signal produces a cardioid polar response, a hypercardioid polar response, or a supercardioid polar response.

8. A differential microphone array (DMA) beamforming method comprising:
obtaining respective microphone signals from two or more microphones;
performing a transformation on the respective microphone signals to obtain frequency bins;
performing beamforming on the respective microphone signals based on a measured time delay associated with an effective distance between the two or more microphones to obtain beamformed signals;
performing an inverse transformation on the beamformed signals to obtain time domain beamformed signals;
applying gains to the time domain beamformed signals;
encoding the time domain beamformed signals to obtain an encoded stream; and
storing the encoded stream.

9. The method of claim 8, wherein performing beamforming further comprises applying respective delay coefficients to the frequency bins of at least one microphone signal of the respective microphone signals.

10. The method of claim 9, wherein the respective delay coefficients are variable for each respective frequency bin.

11. The method of claim 8, wherein an average bin width of the frequency bins is configured to match a Fast Fourier Transform (FFT) length.

12. The method of claim 11, wherein the FFT length is 256.

13. The method of claim 11, wherein the average bin width is approximately 93.75 Hz.

14. The method of claim 11, wherein the effective distance is based on a measured phase difference between the respective microphone signals.

15. A differential microphone array (DMA) beamforming method comprising:
obtaining a first microphone signal from a first microphone disposed in an encasement;
obtaining a second microphone signal from a second microphone disposed in the encasement;
performing a transformation on the second microphone signal to obtain frequency bins;
applying respective delay coefficients to the frequency bins of the second microphone signal to obtain a delayed signal, wherein the respective delay coefficients are based on a measured time delay associated with an effective distance between the first microphone and the second microphone and based on a deviation caused by the encasement;
combining the delayed signal and the first microphone signal to obtain a beamformed signal; and
storing the beamformed signal.

16. The method of claim 15, wherein the effective distance is based on a measured phase difference between the first microphone signal and the second microphone signal.

17. The method of claim 15, wherein the respective delay coefficients are variable for each respective frequency bin.

18. The method of claim 15, wherein an average bin width of the frequency bins is configured to match a Fast Fourier Transform (FFT) length.

19. The method of claim 18, wherein the FFT length is 256.

20. The method of claim 18, wherein the average bin width is approximately 93.75 Hz.
